(19) United States
(12) Patent Application Publication
(10) Pub. No.: US 2007/0283282 A1
(43) Pub. Date: Dec. 6, 2007

(54) Systems and methods for on-demand deployment of software build and test environments

(75) Inventors: Nick Bonfiglio, San Mateo, CA (US); Andrew Ryan, San Mateo, CA (US); Yiping Zhang, San Jose, CA (US); Dan Mercer, Sunnyvale, CA (US)

Correspondence Address: PERKINS COIE LLP, P.O. BOX 2168, MENLO PARK, CA, 94026, US

(73) Assignee: CollabNet, Inc., Brisbane, CA (US)

(21) Appl. No.: 11/788,219

(22) Filed: Apr. 18, 2007

Related U.S. Application Data
(60) Provisional application No. 60/793,018, filed on Apr. 18, 2006.

(51) Int. Cl. G06F 3/00

(52) U.S. Cl. 715/762

(57) ABSTRACT

Systems and methods are described that allow for the dynamic allocation and re-allocation of hardware and software resources to support the build, integration, and test phases of complex software development projects. The invention provides customers who have medium to large development teams, which may be geographically distributed, with an integrated development environment, which includes centralized governance of software code repositories, build systems and test systems. Embodiments of the invention include a centralized, scalable, and dynamic system architecture which allows customers to (1) replicate the internal build, integrate, and test environments that were previously used on the customer premises, (2) provision and re-provision such resources on demand, and (3) seamlessly integrate their internal environments with the system described herein.

### CLAIM OF PRIORITY

This application claims priority to U.S. Provisional Application No. 60/793,018, filed Apr. 18, 2006, which is hereby incorporated by reference in its entirety.

### FIELD OF THE INVENTION

This invention relates to the field of software development, and more specifically, to systems for enabling build and integration testing of large, geographically distributed software development efforts.

### BRIEF DESCRIPTION OF PRIOR ART

Large software projects generally comprise numerous, interactive software modules, which, in turn, may include legacy software, third party applications, and originally developed code; these software projects are often developed by teams that are geographically dispersed. The software development cycle includes “build, “integrate” and “test” phases, as are well-known and understood in the prior art. However, there is a lack of consistency and control present in most software build, integration, and test environments. Commercially developed software is generally developed using source code control systems, such as Subversion or CVS, which provide consistency and audit capabilities to the coding process. This type of rigor is usually lacking in the subsequent steps of the software development lifecycle, i.e., in the build, integration, and test phases.

Another inadequacy of the prior art is the inefficient utilization of computing resources for software build and test. Most enterprises have large numbers of computer systems which are idle because systems are difficult to inventory and re-allocate. As a consequence, there are typically projects that need computing resources for software build and test, and other projects that have a surplus of computing resources. These and other inadequacies of the prior art are addressed by the invention as described herein.

### SUMMARY

The invention comprises systems and methods that allow for the dynamic allocation and re-allocation of hardware and software resources to support the build, integration, and test phases of complex software development projects. The invention provides customers who have medium to large development teams, which may be geographically distributed, with an integrated development environment, which includes centralized governance of software code repositories, build systems and test systems. Embodiments of the invention include a centralized, scalable, and dynamic system architecture which allows customers to (1) replicate the internal build, integrate, and test environments that were previously used on the customer premises, (2) provision and re-provision such resources on demand, and (3) seamlessly integrate their internal environments with the system described herein.

In embodiments, system is delivered as a managed service offering, commonly also referred to as an “Application Services Provider” (ASP) model, or as a “Software as a Service (SaaS)” model. In some such embodiments, the customer creates “nodes”, wherein each node comprises a defined group of hardware/software resources, and a portion of the customer's software modules deployed on such hardware resources. Such embodiments include the ability to automate the deployment and management of all such hardware or software assets that are assigned to that customer. In embodiments of the invention, the customer can view relevant performance parameters for the nodes in real time, and may re-assign or purchase new nodes in real-time. In some such embodiments, the nodes utilize virtual machines which enable such nodes to replicate the software/hardware platforms on which the software projects are to be tested and ultimately operate. These and other embodiments are further described hereinafter.

### BRIEF DESCRIPTION OF THE DIAGRAMS

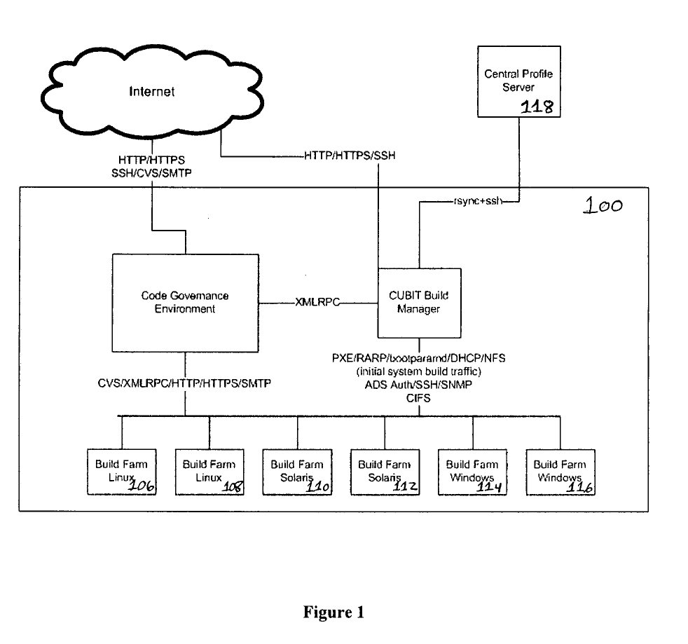

FIG. 1 illustrates a system architecture for embodiments of the invention.

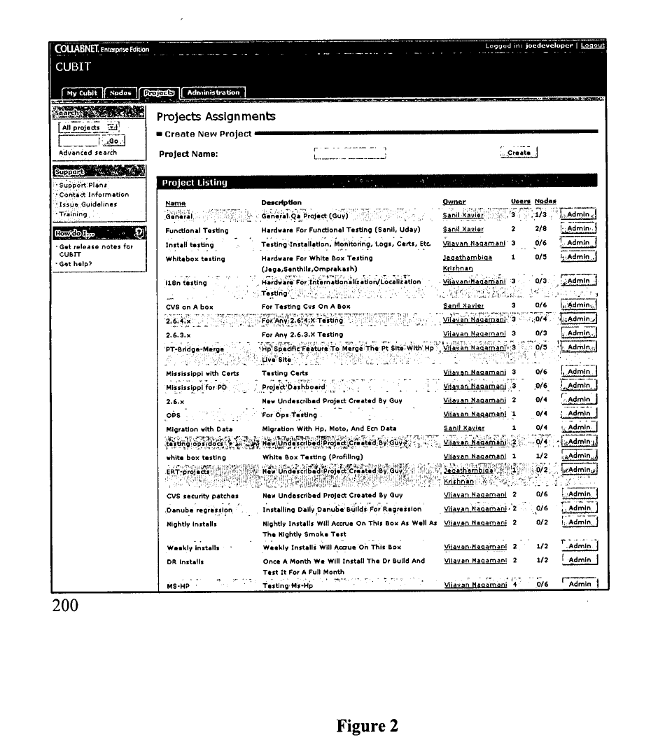

FIG. 2 illustrates a user interface for reporting project assignments in accordance with embodiments of the invention.

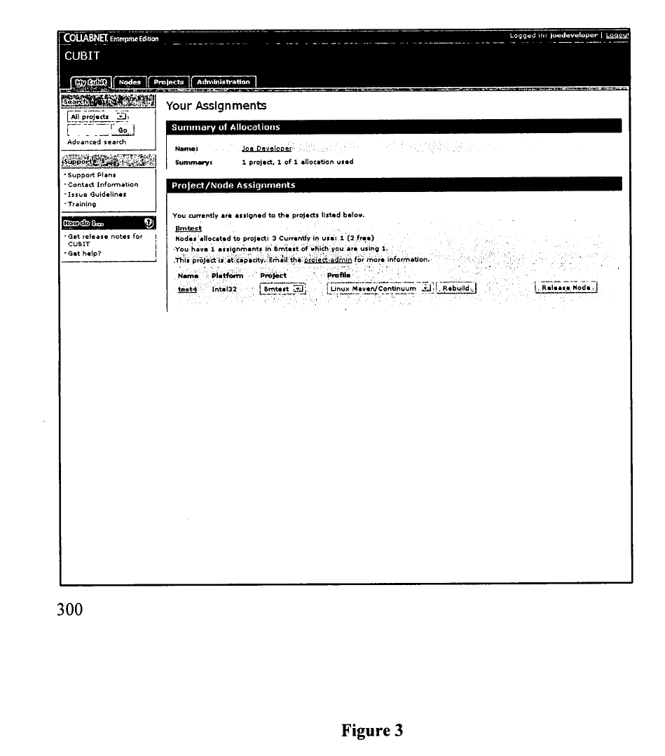

FIG. 3 illustrates a user interface for reporting on software projects specific to a user in accordance with embodiments of the invention.

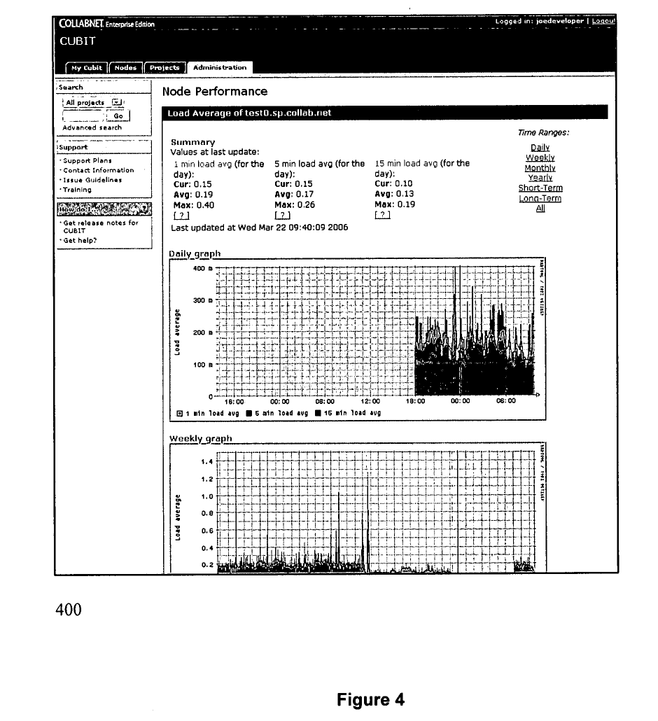

FIG. 4 illustrates a user interface for reporting utilization of nodes in accordance with embodiments of the invention.

### WRITTEN DESCRIPTION

The invention comprises systems and methods that allow for the dynamic allocation and re-allocation of hardware and software resources to govern the build, integration, and test phases of complex software development projects. The invention is sometimes referred to herein by the acronym “CUBIT”, which stands for “CollabNet Universal Build and Integrated Test System”. An objective of the invention is to provide customers who have medium to large development teams, which may be geographically distributed, with an integrated development environment, which includes centralized governance of software code repositories, build systems and test systems.

Embodiments of the invention include a centralized, scalable, and dynamic system architecture which allows customers to (1) replicate in CUBIT the internal build, integrate, and test environments that were previously used on the customer premises, (2) provision and re-provision such resources on CUBIT on demand, and (3) seamlessly integrate their internal environments with CUBIT. In such embodiments, the CUBIT system is delivered as a managed service offering, commonly also referred to as an “Application Services Provider” (ASP) model, or as a “Software as a Service (SaaS)” model. In some such embodiments, the customer creates “nodes” on CUBIT, wherein each node comprises a defined group of hardware resources on CUBIT, and a portion of the customer's software modules deployed on such hardware resources, as further described herein. Such embodiments include the ability to automate the deployment and management of all such hardware or software assets, or “nodes”, that are assigned to that customer on CUBIT. Such embodiments allow customers to track all their development assets globally and maintain true audit and governance of software products. Embodiments of the invention utilize what is often referred to as a “grid computing” architecture, which include a dynamic pool of hardware assets that can be utilized across the CUBIT infrastructure.

Some embodiments of the invention include a user interface to CUBIT which allow a customer to allocate one or more nodes/systems to a pool that can then be dynamically allocated to the customers' individual software projects. Some such embodiments include the use of standard profiles as well as profiles customized for the customers; such customized profiles may, in turn, be provided within CUBIT itself or by third parties. In embodiments of the invention, this user interface may utilize a command-line, or “CLI” interface, a web-based interface, or another type of graphical user interface (GUI), as further described herein.

In embodiments of the invention, CUBIT also includes and utilizes a standard software development repository, such as Concurrent Versioning System, or CVS, or Subversion. Embodiments of the invention also allow the customer software to be loaded on CUBIT for building and testing purposes to be operable on numerous operating systems. In particular, software developed by customers that utilize CUBIT may be intended for deployment upon one or more of a diverse range of operating systems and hardware environments, such as, by way of example but not limitation, versions of Linux (which, in turn, may be vendor-specific, such as versions of Linux offered by Red Hat, or versions of SuSE Linux offered by Novell, Inc.), the Solaris operating systems offered by Sun Microsystems, Inc., various other versions of the Unix operating systems, or versions of the Windows operating system offered by Microsoft Corporation—other examples shall be readily apparent to those skilled in the art. The customer software may also be developed for deployment on particular types of hardware architectures, such as those known as “x-86” architectures developed by Intel Corporation or Advanced Micro Devices, Inc., Sun Microsystems “SPARC” environments, or other such examples as shall be readily apparent to those skilled in the art. Embodiments of CUBIT allow customers to deploy, on-demand, and re-allocate, on demand, nodes that replicate such combinations of hardware and operating systems. In embodiments of the invention, this dynamic allocation of hardware/software platforms may be conducted through a simple user interface, as further described hereinafter.

In embodiments of the invention, customers may have individual users of the CUBIT system who are allowed defined types of roles and permissions with respect to particular software projects of the Customer that are governed by the CUBIT system. These roles and responsibilities of the individual users may be authenticated when such customer logs-in to the CUBIT system. Embodiments of the invention include secure connections to CUBIT, through security protocols such as SSH, or other types of virtual private network protocols, as shall be readily apparent to those skilled in the art. These and other aspects of the invention are further described hereinafter.

Embodiments of the invention allow for the simple determination of resource utilization across a large number of processors utilized in the CUBIT system, and for the rapid re-allocation of resources between Customers' projects. In embodiments of the invention, a customer can quickly locate, by use of a web-based, other GUI-based, or CLI-based interface, processors or clusters of processors on the CUBIT system which have not been recently logged into, or which are not using many CPU cycles. The customer can then convert a machine (e.g., processors or clusters of processors) running a first platform (such as, by way of example but not limitation, a version of Linux) that is assigned to one project to a machine running a second platform (such as, by way of example but not limitation, Windows), that is assigned to another software project.

Embodiments of the invention support such functionality through the use of server virtualization technologies (such as the VMWare technologies offered by VMWare, Inc., a division of EMC Corporation, virtualization technologies offered by Microsoft Corporation, or other alternatives that shall be apparent to those skilled in the art). Such virtualization software allows for multiple virtual nodes to run on single physical machines. Groups comprising one or more virtual nodes may be configured to replicate certain hardware/software platforms on which a particular software project to be hosted such virtual nodes are designed to operate. By way of example but not limitation, suppose that a customer has a first software project designed to operate on a particular configuration of a Linux operating system on an x-86 platform, and a second software project designed to operate on a Solaris operating system on a SPARC platform. The customer may have particular nodes on CUBIT that are assigned to the first software project, and that replicate the platform for the first software project; likewise, the customer may have other nodes on CUBIT that are assigned to the second software project, and that replicate its corresponding platform. In embodiments of the invention, such nodes can be allocated and de-allocated on-demand, and can also be reassigned; by way of example, nodes configured for the first software project and corresponding platform may be, upon request, re-configured for the second software project and corresponding platform.

Embodiments of the invention include a system architecture for supporting such functionality. One such illustrative example is schematically illustrated in FIG. 1. The CUBIT system 100 connects, in embodiments of the invention, to the customers and/or the legacy build systems located at the customer premises via the Internet 102. In embodiments of the invention, the “machines” (e.g., clusters of processors on which nodes are hosted), are contained in one or more “Build Farms” 106-116. Such Build Farms may include nodes configured to replicate specific hardware/software platforms. Embodiments of the invention include a Build Manager 104, which maintains a database of computing nodes and their operating system profiles. In some such embodiments, the Build Manager 104 may be responsible for one or more of the following features of the CUBIT system:
governing customer access into the Build Farm 106-116;
providing unified home directories (i.e., hierarchical directory structures) to customer projects hosted on the Build Farms 106-116;
allocating resources on the Build Farms 106-116 for new customer projects to be hosted on the Build Farms 106-116; and
controlling access to individual systems in the Build Farms 106-116, including authentication of users and enforcement of permitted roles/responsibilities for such users with respect to specific customer projects. Certain security, communications, and directory protocols are depicted in FIG. 1; these are provided for example purposes only, and many alternatives and equivalents shall be readily apparent to those skilled in the art.

The system architecture depicted in FIG. 1 further includes a Central Profile Server 118. This Server allows us to maintain a centralized repository of operating system profiles and configuration information for use by all customers, as well as customer-specific profiles.

An additional component of the system depicted in FIG. 1 is a Code Governance Environment 120. In embodiments, this computing environment hosts the source code for all projects which would be used by CUBIT, as well as the database of usernames, passwords, projects, and permissions. In embodiments of the invention, the information in this database is accessible to the Build Manager 104 via a web service such as, by way of example but not limitation XMLRPC, to the CUBIT Build Manager—other suitable protocols shall be apparent to those skilled in the art. This allows a single repository of authentication and roles to be used for code governance as well as build and test governance.

In embodiments of the invention, after a customer, once CUBIT is activated, the customer can purchase nodes on an as-needed basis, and may then allocate nodes to individual projects. FIG. 2 illustrates an example of a user interface 200 that lists the active nodes and corresponding projects for a customer. In embodiments of the invention, the purchase and allocation of the nodes is conducted by an individual who has been assigned a “Domain Administrator” role. Individual “Project Owners” may thereafter manage their allocations and assign available platform profiles to projects. Individual users have a view of their personal project and node assignment information; FIG. 3 provides an example of a user interface 300 which provides this type of view.

In embodiments of the invention, individual CUBIT users and administrators can monitor the nodes for system health, utilization, and performance; FIG. 4 provides an example of a user interface 400 which illustrates health, utilization, and performance indicators for nodes.

Embodiments of the invention include numerous types of node performance parameters which enable customers to make judgments regarding node allocation/reallocation. These parameters may include, by way of example but not limitation, CPU, memory, network bandwidth, and load parameters. Other relevant parameters shall be readily apparent to those skilled in the art. Users may also direct queries to CUBIT regarding resource utilization. By way of illustration, such queries may be of the following type:
“Show me all the machines in my project with less than 10% CPU utilization over the last 24 hours”
“Show me all the machines in all projects which no one has logged into in more than 7 days”

Many implementations and embodiments of the invention have been provided in the foregoing written description; these have bee provided as examples only, and many equivalents and variants shall be readily apparent to those skilled in the art.

1. A computer network system for replicating software build and test environments comprising:
a plurality of nodes, each of the nodes including one or more processors which run one or more virtual machines, the one or more virtual machines replicating a operating system platform, wherein, at any given time, each of the plurality of nodes may be assigned to a customer;
a repository for maintaining versions of software source code for one or more software projects to be deployed by a customer on nodes assigned to such customer for purposes of performing build and integration testing on such software projects, wherein the software source code to be deployed by the customer is operable upon the operating system platforms for the nodes assigned to such customer;
management resources for allocating and deallocating one or more of the plurality of nodes assigned to the customer upon a request from the customer, wherein such resources are operable to monitor the utilization of the nodes assigned to the customer, and are operable to allocate one or more new nodes to the customer so that the operating system platform replicated by such node is one selected by the customer.

2. The computer network system of claim 1, wherein the computer network system interacts with the customer via a web-based user interface.

3. The computer network system of claim 1, wherein the computer network system is in communication, via an internet connection, to software build and test environments that are based on the customer's premises.

4. The computer network system of claim 1, wherein the computer network system includes user interfaces to report the utilization of the nodes to the customer.

5. The computer network system of claim 1, wherein the computer network system is operable to restrict access to the one or more projects to customer designees assigned to such one or more projects.

6. The computer network system of claim 1, wherein additional nodes may be purchased by a customer via a user-interface on demand, pursuant to prices reported to the customer by such user interface.

7. The computer network system of claim 6, wherein the customer may designate the desired operating system platform to be replicated on such nodes at the time of purchase.

8. The computer network system of claim 1, wherein the computer network system is operable to include and deploy testing scripts that have been developed by or on behalf of the customer for the one or more projects.

9. The computer network system of claim 1, wherein the repository includes CVS.

10. The computer network system of claim 1, wherein the repository includes
Subversion.

11. The computer network system of claim 1, wherein the management resources include one or more relational databases.

12. The computer network system of claim 11, wherein the management resources are operable to monitor, store and report performance parameters for the plurality of nodes.

13. The computer network system of claim 12, wherein the performance parameters may include one or more of CPU utilization, memory utilization, network bandwidth, and number of logins by customer designees.
